(19) United States
(12) Patent Application Publication
(10) Pub. No.: US 2005/0029287 A1
(43) Pub. Date: Feb. 10, 2005

(54) Beverage dispensing system

(76) Inventor: Nigel Mobbs, Worcestershire (GB)

Correspondence Address: BIRCH STEWART KOLASCH & BIRCH, PO BOX 747, FALLS CHURCH, VA, 22040-0747, US

(21) Appl. No.: 10/872,274

(22) Filed: Jun. 18, 2004

(30) Foreign Application Priority Data
Jun. 19, 2003 (GB) 03/4277.5

(51) Int. Cl. B67D 5/56

(52) U.S. Cl. 222/1; 222/129.1

(57) ABSTRACT

A system for dispensing a beverage which is a mixture of stock and water, includes a dispensing apparatus having a water supply thereto, and a container containing the stock, the apparatus further including a controller which in use controls the apparatus to mix water with the stock to make the beverage, and to deliver the beverage to a beverage outlet, and wherein the container includes an identification device which identifies the nature of the beverage to be dispensed, and the dispensing apparatus includes a sensor, which senses the identification device and provides a signal to the controller which identifies the nature of the beverage to be dispensed from the signal.

### BACKGROUND TO THE INVENTION

This invention relates to a system for dispensing a beverage which is a mixture of stock such as a flavouring, colouring or the like which is to be diluted, and water.

### DESCRIPTION OF THE PRIOR ART

Conventionally systems for dispensing a beverage, such as a soft drink, which is a mixture of a stock being syrup and water, have included a water supply, a syrup supply, a mixing device for mixing these together with an appropriate volume ratio of water to syrup, and a dispensing nozzle from where the mixed beverage is dispensed. The water supply, in most examples, has included some cooling apparatus for cooling the water, and also in most examples, a carbonating device for carbonating the beverage prior to its dispensing.

Particularly in outlets where only a small volume of beverage is dispensed, the cost of supplying the system and for maintaining the system, can far outweigh the possible profits to be made from selling beverage. Maintenance costs are high both to ensure that the correct proportions of water and syrup are consistently mixed, but also in the hygienic maintenance of the system particularly in cleaning out the dispensing head from where the beverage is dispensed. Accordingly, in outlets which sell only a small volume of beverage, it is more attractive to retail bottled beverages.

Even though for a large conventional installation, some components, such as the cooling apparatus and/or carbonising apparatus where provided, may be shared, where different beverages are to be dispensed it is a requirement for an individual mixing device and dispensing nozzle, together with associated plumbing, to be provided for each different beverage. Where the outlet is a bar, the provision of a multitude of different dispensing nozzles can provide a logistics problem in accommodating them.

Moreover, the syrup for the or each beverage is provided in large volumes in syrup containers. Thus a conventional system cannot economically be used to dispense small volumes for example of a specialist beverage on a trial basis, without risking wasting a large volume of the syrup.

### SUMMARY OF THE INVENTION

According to a first aspect of the invention we provide a system for dispensing a beverage which is a mixture of stock and water, the system including a dispensing apparatus having a water supply thereto, a container containing the stock, the apparatus further including a controller which in use controls the apparatus to mix water with the stock to make the beverage, and to deliver the beverage to a beverage outlet and wherein the container includes an identification device which identifies the nature of the beverage to be dispensed, and the dispensing apparatus includes a sensor which senses the identification device and provides a signal to the controller which identifies the nature of the beverage to be dispensed from the signal.

Thus a wide variety of different beverages may be dispensed by a user selecting an appropriate container which is identified by the dispensing apparatus so that the stock may be mixed with an appropriate volume and type of water in the apparatus, so that a desired beverage may be dispensed. Thus simply by selecting an appropriate container, a large, medium or small volume beverage may be dispensed for example, and/or a carbonated or a non-carbonated drink may be dispensed, and the water of the supply may be cooled or heated, all depending upon the identification device of the container.

In one embodiment, the identification device of the container may include a marking and the sensor is an optical sensor. Such a marking may be a bar code in which case the sensor is a bar code reader.

Additionally or alternatively the identification device may include a physical feature of the container, such as the shape of the container or the position and/or number of notches in a container wall for examples, the position(s) of which relative to the dispensing apparatus indicates the nature of the beverage to be dispensed by mixing water with the stock contained within the container, and in each case, the feature being sensed optically and/or physically by the sensor.

Preferably, to ensure proper registration between the identification device and the sensor, the dispensing apparatus and the container have inter-engaging formations which enable the container to be received by the apparatus in an operative position in which the identification device is sensed by the sensor.

In one arrangement, upon a user selecting a container for producing a desired beverage, the container is locatable in position upon the manual insertion of the container in the apparatus. However alternatively, the user may place the container in a position relative to the dispensing apparatus, and the container may be locatable in its operative position by a mechanical loading device which moves the container into the operative position where the sensor senses the identification device.

To provide a beverage of a volume selected by the user choosing a container appropriate to the desired volume, the controller may meter the water to provide a predetermined volume of water for mixing with the stock, in response to the signal from the sensor.

The system may include a gassifying device e.g. for carbonating the water, e.g. integrated into the dispensing apparatus, or provided remotely, and the controller may mix one of carbonated water and non-carbonated water with the stock, in response to the signal from the sensor. Thus a user may choose a container appropriate to obtain a carbonated or non-carbonated beverage.

At least part of the water supply to the apparatus may be a water supply from a cooling and/or heating unit wherein the controller mixes water in a predetermined temperature range with the stock, in response to the signal from the sensor, e g. by mixing cooled or heated and non-cooled or non-heated water in appropriate quantities to achieve a water temperature within the predetermined temperature range.

In another arrangement the dispensing apparatus may include a cooling and/or heating unit to change the temperature of the water of the supply, and wherein the controller mixes water in a predetermined temperature range with the stock, in response to the signal from the sensor.

In each case, a user may obtain beverage at a temperature appropriate for the nature of the beverage to be dispensed and according to the user's choice. For example a hot or cold fruit squash/juice drink may be dispensed.

If desired, the system may include an ice dispenser and in response to an appropriate signal from the sensor which indicates the user's choice of container is for an iced drink, the controller may dispense ice for the beverage on receipt of an appropriate signal from the sensor. The ice dispenser may be integrated with the dispenser apparatus or separate.

In one embodiment, the container may include a water inlet and the beverage outlet which are each sealed prior to receiving the container in the apparatus, and immediately prior to or upon receiving the container in the apparatus, the water inlet at least is unsealed to permit water to enter the container from the dispensing apparatus. The beverage outlet may become unsealed as pressure builds up within the container, as the water is fed into the container or otherwise, whereby the water and stock are mixed in the container as water flows from the water inlet to the beverage outlet and the beverage is dispensed directly from the beverage outlet.

In another arrangement in which the stock may be emptied from the container, the water and stock are mixed as they each flow towards a beverage outlet of the apparatus. Thus the container may include a rupturable seal which is ruptured when the container is received by the apparatus to permit the stock to flow from the container.

In each case, the container may be disposable, automatically or manually, after its stock has been dispensed

According to a second aspect of the invention we provide a method of using the system according to the first aspect of the invention, the method including selecting from a store of containers a container filled with stock appropriate for fulfilling a customer's order, inserting the container into the apparatus, the selected container having an identification device which identifies the nature of the beverage to be dispensed, sensing the identification device with the sensor and providing a signal to the controller which identifies from the signal the nature of the beverage to be dispensed, and dispenses the beverage depending upon the signal.

The method may include subsequently removing the container from the apparatus and disposing of the container.

According to a third aspect of the invention we provide a container for use in a beverage dispensing system according to the first aspect of the invention wherein the container includes stock to be diluted with water from the dispensing apparatus, and an identification device to identify the nature of the beverage to be dispensed, the identification device being readable by the sensor of the apparatus.

### BRIEF DESCRIPTION OF THE DRAWINGS

Embodiments of the invention will now be described with reference to the accompanying drawings in which:—

FIG. 1 is an illustrative side view of a beverage dispensing system in accordance with the first aspect of the invention;

FIGS. 2a and 2b are illustrative perspective views of a beverage dispensing apparatus of a system in accordance with the invention in different stages of use;

FIGS. 3a to 3c are illustrations of alternative kinds of container for use in the system of the present invention

### DESCRIPTION OF THE PREFERRED EMBODIMENTS

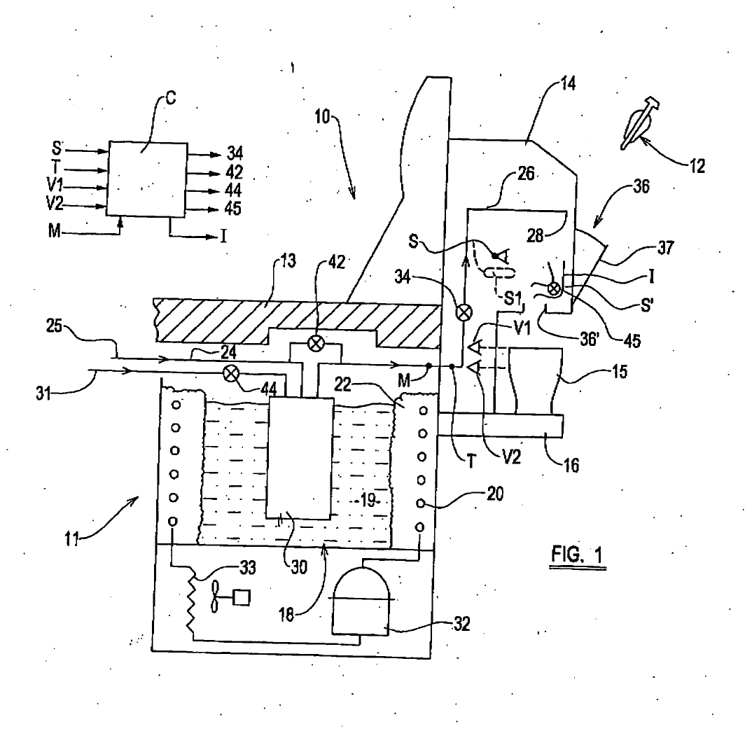

Referring first to FIG. 1, there is shown a system 10 for dispensing a selected one of a plurality of different beverages, each beverage being a mixture of a flavouring, colouring or the like, for example stock, which is to be diluted, and water. In the example to be described, the stock is a syrup which when mixed with water, in this example which may be cooled and/or carbonated water, provides a beverage which is a so called “soft drink”. However the stock need not be a liquid but may be a solute or other flavouring and/or colouring, or may for example be a mixture of health enhancing salts and minerals.

The system 10 includes a beverage dispensing apparatus 11, and a container 12 for syrup. The apparatus 11 is shown mounted on a bar 13, and includes a housing 14 in which in use the container 12 is received, and from which beverage is dispensed into a drinking vessel 15 which may be supported on a shelf 16 of the apparatus 11 as shown, at a point of beverage delivery.

Beneath the bar 13 in the housing 14, there is provided in this example a cooling unit 18 including a reservoir of a cooling liquid 19, which is cooled by expanded refrigerant, or another cooled fluid which passes through the reservoir 19 in one or more cooling coils 20. The reservoir 19 is within a highly insulated bath, and typically in use an ice bank 22 is created around the cooling coil(s) 20.

Water is supplied to the cooling unit 18 from a water inlet 25, and as hereinafter explained, the water passes along a feed line 24, through the reservoir of cooled liquid, to a conduit 26 which extends to a water outlet 28 above the shelf 16. Within the reservoir 19 there is located a carbonating device 30 to which a supply of pressurised carbon dioxide is fed along a gas conduit 31 from externally of the apparatus 11. In the carbonating device 30, the water may be carbonated as it is cooled, as it flows in the feed line 24 to the conduit 26 towards the water outlet 28.

The refrigerant for cooling the reservoir 19 of the cooling unit 18, may be refrigerated by a local compression pump 32 and evaporator 33 as indicated, or may be located remotely from the beverage dispensing apparatus 18, e.g. in a cellar, and the refrigerant pumped to the cooling coils 20. Further alternatively, the entire cooling unit 18 may be located externally of the dispensing apparatus 11, for example to supply cooled water to the apparatus, and/or the carbonating unit 30 may be provided externally of the dispensing apparatus 11.

Along the conduit 26 for the water (which may optionally be cooled and carbonated as hereinafter described), between the cooling unit 18 and the water outlet 28, there is provided a control valve 34, the operation of which may be controlled by a controller C, to meter water permitted to pass to the water outlet 28, during dispensing of the beverage, the water flow along the conduit 26 being measured by a metering sensor M.

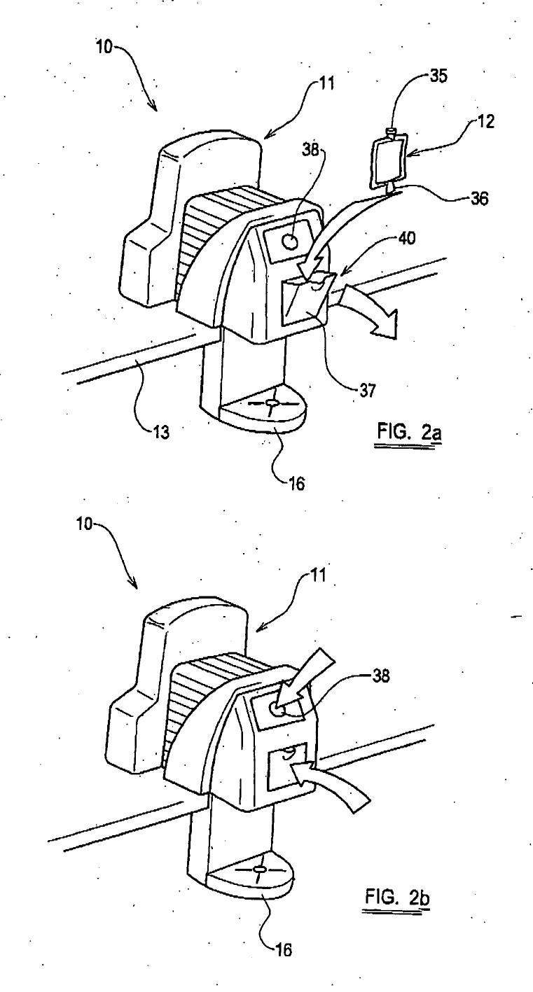

Referring to FIGS. 2a and 2b, a part only of the beverage dispensing apparatus 11 is illustrated more figuratively. In this example, the container 12 is a flexible walled sachet which contains a predetermined quantity of the syrup, the container 12 having a water inlet 35, and a beverage outlet 36. The beverage dispensing apparatus 11 includes a mechanical container loading device 40 which includes a moveable flap 37 which may be opened as illustrated in FIG. 2a, to allow the container 12 manually to be inserted into the apparatus 11. As the flap 37 is closed, the container 12 is received in an operative position, such that the water inlet 35 is located immediately below the water outlet 28 of the apparatus 11. In fact, the outlet 38 preferably has a spout which during the loading action, causes the water inlet 35 which up until now has been sealed, to be ruptured.

The user may then operate a “dispense” control 38 (but operation of the apparatus 11 may be automatic when the presence of the sachet 12 is determined), and as a result the controller C opens the control valve 34 for a predetermined time and/or a predetermined amount only, but preferably until the metering sensor M determines that a predetermined volume of water has been dispensed, to dispense a metered volume of water from the water outlet 28.

The water is constrained to flow into the water inlet 35 of the container 12, and as a result the build-up of pressure in the container 12 may cause the up until now sealed beverage outlet 36 to be raptured, so that the mixed syrup and water flow directly from the container 12 through the beverage outlet 36, into the drinking vessel 15 positioned below. Alternatively, the apparatus may include a device positively to rupture the beverage outlet seal 36 to allow the water to flow through the container 12, but in each case mixing of the syrup and water will occur in the container 12 as the water and syrup flow.

After the metered volume of water has been dispensed, the flap 37 may be opened and the now empty container 12 automatically or manually disposed of, although of course it is within the scope of the present invention for the action of opening of the flap 37 to result in the mechanical removal of the container 12, for example into a waste receptacle.

It will be appreciated that a container 12 may be selected from a store of containers which may contain different syrups or other stock, which may be alternatively dispensed as appropriate to fulfil a customer's order. For example, containers 12 containing the same or different stock may require different metered volumes of water to be dispensed, and/or in some instances for the water not to be carbonated or cooled or heated to a temperature within a predetermined temperature range. Further alternatively, different containers 12 may contain the same volume of the same stock, but the containers 12 may indicate upon them different conditions under which the beverage is to be dispensed, i.e. cooled, heated, carbonated or non-carbonated. Thus the containers 12 of the store may have human readable markings relating to the nature of the beverage to be dispensed, and the conditions under which the beverage is to be dispensed, or such containers may be differentiated by being stored e.g. in individual bins for particular beverage types, from which a user selection may be made.

Each container 12 include an identification device D appropriate for identifying to a machine sensor S, the nature of the beverage to be dispensed using the individual container 12. Thus the fact that a user may have selected a container 12 for obtaining a cooled, carbonated medium volume beverage, may be identified to the machine sensor S by the identification device D.

Thus preferably, as or when the container 12 is received in the beverage dispensing apparatus 11, the sensor S senses the identification device D and provides an appropriate signal to the controller C.

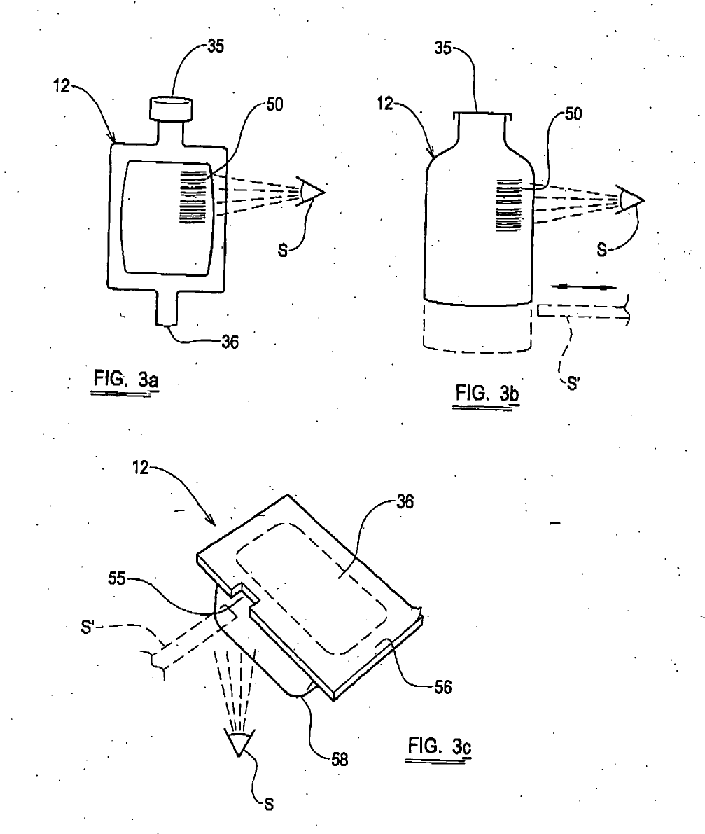

Thus different containers 12 having different stock/beverage dispensing conditions, may be marked, for example with a bar code such as shown at 50 in FIGS. 3a and 3b, or the container may be physically configured in particular shapes, so that the sensor S may recognise the identification device D and provide an appropriate input signal to the apparatus controller C.

In FIG. 3b there is indicated in dotted lines a physical shape sensor S′ which senses the shape of the (bottle shaped) container 12 and particularly senses whether the container 12 is a large container 12 (indicated as in dotted lines) for containing a large volume of syrup or other stock for dispensing a large volume beverage, or a small container 12 (indicated in full lines) for containing a smaller volume of stock for dispensing a smaller volume beverage.

Alternatively in FIG. 3c, the an optical sensor S optically senses a physical feature of the container 12, namely the position/size of a notch 55 which is indicative of the nature of the stock and/or the conditions under which the beverage is to be dispensed. Such a notch may alternatively be recognisable by a physical sensor such as a mechanical feeler S′.

In each case, the sensor S/S′ may sense the identification device 50/55, which may include a marking such as bar code 50 in addition to a physical feature such as notch 55 if desired, and provide an appropriate signal to the controller C.

The controller C, from the signal from the sensor S/S′, may determine the nature of the stock in the user selected container 12 loaded into the apparatus 11, or at least determines the nature of the desired beverage to be dispensed into the cup 15.

Examples of the dispensing of different beverages will now be given by way of further explanation.

In the event that a user selects a container 12 appropriate for dispensing a large volume of cooled carbonated drink such as a cola, the selected container 12 will have an appropriate identification device D to differentiate it from alternative containers 12.

The sensor S/S′ upon sensing the identification device D will signal the controller C, which in response provides for a predetermined volume of cooled and carbonated water (by e.g. metering the water passing) to be passed along conduit 26 for mixing with the stock, so that the selected cooled carbonated beverage is dispensed into the cup 15.

In the event that a user selects a different container 12 appropriate for dispensing a smaller volume of cooled but un-carbonated drink such as a fruit squash or juice, the selected container 12 will again have an appropriate identification device D.

The sensor S/S′ upon sensing the identification device D will signal controller C which in response provides a smaller predetermined volume of cooled water along conduit 26. The controller C may render the carbonating device 30 inoperative, for example by allowing the water supply to by-pass the carbonating device 30, or by closing a valve 44 from the external gas supply 31, for examples only.

In the event that a user selects a different container 12 appropriate for dispensing a certain volume of beverage, which may be neither carbonated nor cooled, or only slightly cooled, e.g. an energy drink, the selected container 12 will have an appropriate identification device D.

The sensor S/S′ upon sensing the identification device D will signal controller C which in response provides the predetermined volume of water for mixing with the stock, whilst by-passing the carbonating device 30 or closing the gas valve 44, and only passing a proportion (or none) of the water through the cooling unit 18, for example opening a by-pass valve 42. Thus by monitoring the temperature of the water flowing along the conduit 26, e.g. by a temperature sensor T, water within a predetermined temperature range may be provided for mixing with the stock appropriate for the selected beverage.

Other means of controlling the extent of cooling and/or carbonation may be utilised. Indeed in another example, the temperature of water supplied may be increased by a heater unit to bring the temperature of the water provided for mixing with the stock to an appropriate temperature for a selected beverage to be dispensed, as identified by an appropriate identification device D.

Various modifications may be made without departing from the scope of the invention. For example, the water may be gassified by another gas than carbon dioxide, for example by oxygen, to provide a gassified beverage with may have energy level enhancing properties.

The apparatus 11 need not include a cooling unit 18 or carbonating or other gassifying device 30 which may be provided remotely, particularly where a common cooling unit 18 and gassifying device 30 are provided to supply cooled and/or gassified water to a plurality of beverage dispensing apparatus 11, e.g. in a commercial environment.

In FIG. 3b a container 12 is shown which does not include a beverage outlet 36. With this kind of container 12, the container 12 may be inverted in the apparatus 11, and a rupturable seal 35, e.g. a foil cap, may be ruptured to allow the stock contents of the container 12 to flow from the container 12 for mixing with the water, e.g. when flowing with the water to a beverage outlet 36′ (see FIG. 1) from the dispensing apparatus 11.

In FIG. 3c the container 12 shown has a rigid wall 56 in which there is an opening closed by a foil seal 36. A notch 55 is provided at an appropriate position in the wall 56 to identify the nature of the beverage to be dispensed when the container 12 is used.

The container 12 includes a chamber 58 containing stock to release the stock, closed by the foil seal 36 which is ruptured in the apparatus 11, e.g. upon introducing the container 12 into the apparatus 11, and the stock is tipped out, or flushed out by the water, and mixed with the water as they each flow to the beverage outlet 36′ of the apparatus 11.

The example of mechanical loading device 40 for the containers 12 is only exemplary. In another embodiment, the container 12 may be received in and mounted by the apparatus 11 manually, but in each case, inter-engaging formations of the container 12 and the apparatus 11 may ensure proper registry of the container 12 with the sensor S/S′ to enable the identification device to be identified.

In FIG. 1, there are illustrated filter optical sensors V1 and V2 adjacent the beverage outlet 36′. These may be provided to detect the presence of the cup 15, and to enable different sized cups 15 to be identified. Thus in the event that a large volume beverage is selected by a user, but a small volume cup 15 only is placed to receive the beverage, the controller C may be programmed not to dispense the beverage but to provide a warning to the user that a larger cup 15 is required.

One or more than two such sensors V1 and V2 may be provided to distinguish between different size/configuration cups 15 as required.

The identification devices D of the containers 12 may identify the actual kind of beverage to be dispensed and if desired the dispensing apparatus 11 may include a display to confirm to a user the kind of beverage to be dispensed and the conditions of dispensing e.g. the volume, temperature range and whether carbonated or not of the beverage.

Although as described, the beverage dispensing apparatus 11 has been provided on a bar 13, the apparatus 11 may be a free standing apparatus, and particularly where provided with an integral cooling unit 18 and gassifying device 30, the apparatus 10 may be adapted for use in a domestic environment so that a domestic user may make at home, soft drinks using containers of syrup, or other beverages, and thus avoid the need to carry from the shops volumes of such beverages which are, in the main, water.

If desired, by selecting an appropriate container 12 from the store, a user may select an iced beverage, in which case the controller C may operate an ice dispenser 1 which may be located in the dispensing apparatus 11 near to the cup 15, the controller C providing less water for mixing with the stock to compensate for the cup 15 volume occupied by the dispensed ice.

1. A system for dispensing a beverage which is a mixture of stock and water, the system including a dispensing apparatus having a water supply thereto, a container containing the stock, the apparatus further including a controller which in use controls the apparatus to mix water with the stock to make the beverage, and to deliver the beverage to a beverage outlet and wherein the container includes an identification device which identifies the nature of the beverage to be dispensed, and the dispensing apparatus includes a sensor which senses the identification device and provides a signal to the controller which identifies the nature of the beverage to be dispensed from the signal.

2. A system according to claim 1 wherein the identification device of the container includes a marking and the sensor is an optical sensor.

3. A system according to claim 2 wherein the identification device is a bar code and the sensor is a bar code reader.

4. A system according to claim 1 wherein the identification device includes a physical feature of the container which is sensed by the sensor.

5. A system according to claim 4 wherein the physical feature relates to a shape of the container the position of which relative to the dispensing apparatus indicates the nature of the stock contained within the container.

6. A system according to claim 1 wherein the dispensing apparatus and the container have inter-engaging formations which enable the container to be received by the apparatus in a position in which the identification device is sensed by the sensor.

7. A system according to claim 6 wherein the container is locatable in an operative position upon the manual insertion of the container in the apparatus.

8. A system according to claim 6 wherein the container is locatable in an operative position by a mechanical loading device which moves the container into the operative position where the sensor senses the identification device.

9. A system according to claim 1 wherein controller meters the water to provide a predetermined volume of water for mixing with the stock, in response to the signal from the sensor.

10. A system according to claim 1 which includes a gassifying device for carbonating the water, and the controller mixes one of carbonated water and non-carbonated water with the stock, in response to the signal from the sensor.

11. A system according to claim 1 wherein at least part of the water supply to the apparatus is a water supply from one of a cooling and heating unit wherein the controller mixes water in a predetermined temperature range with the stock, in response to the signal from the sensor.

12. A system according to claim 1 wherein the dispensing apparatus includes at least one of a cooling and heating unit to change the temperature of the water of the supply, and wherein the controller mixes water in a predetermined temperature range with the stock, in response to the signal from the sensor.

13. A system according to claim 1 wherein in response to an appropriate signal from the sensor, the controller dispenses ice for the beverage on receipt of an appropriate signal from the sensor.

14. A system according to claim 1 wherein the container includes a water inlet and the beverage outlet which are each sealed prior to receiving the container in the apparatus.

15. A system according to claim 14 wherein immediately prior to or upon receiving the container in the apparatus, the water inlet at least is unsealed to permit water to enter the container from the dispensing apparatus, the beverage outlet becoming unsealed as pressure builds up within the container, as the water is fed into the container, whereby the water and stock are mixed in the container as water flows from the water inlet to the beverage outlet, and the beverage is dispensed directly from the beverage outlet.

16. A system according to any one of claim 1 wherein the water and stock are mixed as they each flow towards a beverage outlet of the apparatus.

17. A system according to claim 16 wherein the container includes a rupturable seal which is ruptured when the container is received by the apparatus to permit the stock to flow from the container.

18. A system according to claim 1 wherein the container is disposable after its stock has been dispensed.

19. A method of using a system for dispensing a beverage which is a mixture of stock and water, the system including a dispensing apparatus having a water supply thereto, a container containing the stock the apparatus further including a controller which in use controls the apparatus to mix water with the stock to make the beverage, and to deliver the beverage to a beverage outlet, and wherein the container includes an identification device which identifies the nature of the beverage to be dispensed, and the dispensing apparatus includes a sensor which senses the identification device and provides a signal to the controller which identifies the nature of the beverage to be dispensed from the signal the method including selecting from a store of containers a container filled with stock appropriate for fulfilling a customer's order, inserting the container into the apparatus, the selected container having an identification device which identifies the nature of the beverage to be dispensed, sensing the identification device with the sensor and providing a signal to the controller which identifies from the signal the nature of the beverage to be dispensed, and dispensing the beverage depending upon the signal.

20. A method according to claim 19 wherein the method includes subsequently removing the container from the apparatus and disposing of the container.

21. A container for use in a beverage dispensing system wherein the container includes stock to be diluted with water from the dispensing apparatus, and an identification device to identify the nature of the beverage to be dispensed, the identification device being readable by the sensor of the apparatus.
